(19) United States
(12) Patent Application Publication
(10) Pub. No.: US 2007/0062650 A1
(43) Pub. Date: Mar. 22, 2007

(54) Rolling shuttered door having collision protection

(76) Inventor: Petra Rejc, Landshut (DE)

Correspondence Address: NATH & ASSOCIATES, 112 South West Street, Alexandria, VA, 22314, US

(21) Appl. No.: 10/571,524

(22) PCT Filed: Aug. 19, 2004
(86) PCT No.: PCT/EP04/09315

§ 371 Date: Jun. 8, 2006

(30) Foreign Application Priority Data
Sep. 12, 2003 (DE) 103 42 302.8

(51) Int. Cl. E06B 9/08

(52) U.S. Cl. 160/133

(57) ABSTRACT

The invention relates to the a rolling shuttered door (1), in particular, to a fast-moving industrial door, comprising a door leaf (2) covering the door opening and being guided in lateral guides (3) and being formed, e.g. as an armor of lamellae, flexible hangings etc. Accordingly, the door characterizes itself, in particular, in that the door leaf (2), in a sub-section facing the footprint of the rolling shuttered door (1), is divided in several parts extending in the direction of movement of the rolling shuttered door (1) such that there is provided a peripheral part on both sides being guided in lateral guides (3), and a central part extending between the two peripheral parts and being detachably fixed to the peripheral parts. It is thus achieved that the door leaf and the elements thereof are less susceptible to damage from external impact such as when colliding with a fork-lift truck.

The invention relates to a rolling shuttered door, in particular, a fast-moving industrial door, having a door leaf covering the door opening and being guided in lateral guides, and formed e.g. as an armor of lamellae, flexible hangings, etc.

Many such rolling doors are known in practice, which have been tried and tested for a long time. They serve as a closure for openings of various kinds both in the private and in the commercial sector. As a result of the opening motion, the door leaf is coiled in the area of the lintel of the door and, with respect to the other sheets of the coiled door leaf, guided in a contactless manner in a round spiral or an elongated spiral. The previous embodiment is particularly used for industrial application purposes, as it enables high movement speeds to be achieved in view of long service life and reliability.

Such fast-moving industrial doors have proved to excel in reliably closing off highly frequented door openings. Owing to high operating speeds of 3 m/s and more, which are frequently achieved, it is often possible to close such industrial doors between two subsequent passages of a fork-lift truck or the like and to thus create protection from climatic influences, draft or a loss of air-conditioned atmosphere in a room. However, considerable design-related efforts need to be undertaken to design a door system such that it may withstand the dynamic stress loads occurring with such high speeds in the long run. It is particularly necessary to guide the door leaf precisely and at low friction.

In the German patent applications DE 40 15 214 A, DE 40 15 215 A, and DE 40 15 216 A, examples of such rolling shuttered doors are shown, wherein the door leaf is formed of a multitude of aluminium lamellae connected to each other, which allow a bending motion to be performed. Hinged bands are superimposed on these lamellae, with rollers being arranged in the hinge portion of these hinged bands which are guided in lateral guiding rails of these industrial doors. These guiding rails are bent in the upper area of the door opening towards the inside of the door such that, in the open position of said industrial door, the door leaf is provided as an elongated coil in the area of the door lintel, with the individual lamellae being stored therein in a contactless manner. A terminating element commonly provided with a sealing lip or the like on its bottom side forms the part of the door leaf terminating to the ground side.

A further example for such a fast-moving industrial door is known from DE 199 15 376 A1, in which the lamellae are made of extruded plastic such as GFK or PMMA, and which may entirely or only partially comprise a transparent design. In accordance with the design of an industrial door as described in the prior art, the door leaf, in the open position, is accommodated in a spiral section having a continuously bent spiral shape in the area of the door lintel. As a result, the design of the door leaf having entirely or partially transparent lamellae provides the advantage of enabling to look through the other side of the door even when the door is closed. Accordingly, already before the door is opened, a fork-lift truck driver is able to check whether the driveway on the other side of the door is clear.

Finally, the so-called “High Speed Turbo Roll-Up Door STR” by the applicant is another door known from practice. The door leaf of said industrial door comprises flexible hangings fixed to a plurality of stiffening profiles each of which extends across the door leaf in cross direction to the lateral guides, connecting two hinge members from the hinged bands associated to each other. Together with the hinged bands, the stiffening profiles thus form a kind of supporting scaffold, which provides for mechanical stability of the door leaf. On the other hand, the flexible hangings create a planar closure so that this door leaf is altogether characterized by having a low weight. Just as in the already discussed prior art designs of industrial doors, said door leaf is guided on both sides by means of rollers engaging with the hinge members and allows to be guided in the area of the lintel in a contactless manner in a spiral or in an elongated coil. Therefore, said industrial door allows to be operated at very high speeds of e.g. 4 m/s. Since the hangings of this industrial door, which is known from practice, are moreover fastened to each stiffening profile by means of a reinforcing strip engaging with an undercut groove at the respectively associated stiffening profile, the hanging is reliably prevented from bulging out, for example under wind load. In addition, said hangings allow to be divided into individual segments for enabling sub-sections of the door leaf to be designed transparently so as to provide the already discussed effect of being able to inspect the area behind the closed door.

However, all of these known designs of rolling shuttered doors have the disadvantage of getting frequently damaged in collisions with, e.g., fork-lift trucks or the like, such that they may only be used on a limited basis or may not be used any more. This is particularly the case, when the movement speed of the door is very high, and, therefore, cannot always be correctly evaluated by the drivers of the vehicles passing through the door opening as a result thereof. In this context, the terminating element often attached to the bottom end of the door leaf is endangered the most, as it may be hit just when the door leaf has not opened properly or may encounter objects in the plane of the door leaf during the closing process. While the latter problem may be avoided by providing a safety system in the manner of a door light curtain such as is known from DE 197 39 543 A and DE 197 39 544 A, collisions caused by vehicles arriving from the side cannot always be avoided.

The usual consequence of such a collision is a deformed or broken terminating element, and some plastic or aluminium lamellae adjacent to the terminating element, or a partial segment of the flexible hangings and individual stiffening profiles from the High Speed Turbo Roll-Up Door STR, which is known from practice, might just as well be damaged. Thus, these elements are destroyed and need to be replaced, which requires time and manpower. Furthermore, it is often necessary to have corresponding spare parts to be delivered on site, so that the rolling shuttered door is temporarily unable to sufficiently close the door opening.

In addition, it is known from conventional rolling shuttered doors having flexible hangings such as the ones described, e.g., in the German patent specifications DE 43 13 062 A1, and DE 43 13 063 A1 to provide a flexible guiding element on both sides at the terminating profile which loosely engages with the lateral guides in the manner of a lug and is guided therein. Furthermore, with this prior art rolling shuttered door, the terminating element is formed of plastic having low flexural stiffness and high elastic deformability in view of sufficient impact resistance, such that it may be elastically deflected upon impact of a force in a direction perpendicular to the door leaf plane. If such deflection exceeds a certain amount, this will result in that the flexible guide elements finally become disengaged from the lateral guiding tracks, with the terminating element thus exiting the guide altogether. In this prior art rolling shuttered door, a failure routine enables the door leaf to be lifted automatically and to independently reenter the upper end of the guiding track via a funnel-shaped extension. Since, owing to the already mentioned advantageous material properties, the terminating element is especially suitable for withstanding such external influence in a non-destructive way, it is usually possible to smoothly continue the operation of said prior art rolling shuttered door.

However, said prior art collision protection system has its limitations, because the terminating element cannot be formed to have any degree of “softness”, as it would otherwise no longer serve its purpose as a reinforcing element. From a certain degree and/or a certain frequency of collisions, said element is also subject to being destroyed. Furthermore, there are various reasons for the rolling shuttered door known from DE 43 13 062 A1 and DE 43 13 063 A1 not to be suitable for high speed operation. For example, the hangings are only loosely held in the lateral guiding tracks, such that they may be disengaged from the vertical guides of the door opening when subjected to strong wind forces or any other manually exerted impacts, and other loading cases are created. However, for a high-speed operation, it is necessary for the door leaf to be precisely and reliably guided in the lateral guides, which is conventionally enabled by the rollers attached to the hinge members as explained earlier in this application. It is only such a precise, contactless low-friction guiding process of the door leaf which enables to reliably take up such dynamic loads occurring at such high speeds. While the collision protection as known from both DE 43 13 062 A1, and DE 43 13 063 A1 may have proved well for use in a rolling shuttered door having flexible hangings and being operated at speeds of a maximum of 2 m/s; it is, however, not suitable for being used in a fast-moving industrial door.

Thus, what is needed is a rolling shuttered door, in particular, a fast-moving industrial door, which, even in case of collision, is not necessarily damaged to such a degree making it necessary to replace parts, with its operativeness thus being temporarily limited.

It is therefore an object of the invention to further develop a rolling shuttered door in accordance with the preamble such that the door leaf is less susceptible to destruction of elements of the door leaf in case of an external impact such as collisions with a fork-lift truck.

This object is achieved by a rolling shuttered door having the features of claim 1, which is particularly characterized in that, in a sub-section facing the footprint of rolling shuttered door, the door leaf is divided in several parts extending in the direction of the movement of the rolling shuttered door such that there is provided a peripheral part on both sides, which is guided in the lateral guides, and that at least a central part extends between the two peripheral parts which is detachably held to the peripheral parts.

The invention thus suggests a completely new design in that the door leaf is for the first time made up of several parts in one sub-section thereof, with these parts extending in the movement direction of the rolling shuttered door being able to deflect from each another in the door leaf's plane. It is thus possible for the central part of the door leaf being commonly affected by collision to avoid being hit as a result of an external impact. Accordingly, any damage affecting the operativeness of the door leaf may be effectively prevented. In order to recover the door leaf's function of providing closure, it will be sufficient to again return the swiveled out central part to the plane of adjacent peripheral parts and to recreate the retaining connection.

According to the invention, even in case of a collision, the door leaf itself will be reliably held in the lateral guides, since the two peripheral parts are not deflected by the central part. The operativeness of the inventive rolling shuttered door is thus also available following a collision event.

Further, the inventive rolling shuttered door is capable of being provided with few constructive measures and without affecting the running characteristics as achieved in conventional systems. While additionally comprising reliable collision protection, the door is not susceptible to any external impacts, with the danger of damaging the door leaf being considerably reduced.

The inventive multi-part design of a door leaf in the bottom sub-section may thus be realized in principle in all known rolling shuttered door systems, so that the invention offers versatile possibilities of application.

Advantageous further embodiments of the inventive rolling shuttered door are the subject-matter of the sub-claims.

Thus, the door leaf of the rolling shuttered door may comprise a hinged band on both sides thereof having a multitude of hinge members connected to each other, and allowing a bending motion to be performed, with said hinge members being guided in the lateral guides, and with the door leaf further comprising a ground-side terminating element, and, attached to the door leaf, in a respectively adjacent relationship to the hinged band on the side facing away from the lateral guides, at least in the area of the terminating element, there is provided an additional hinge means, which is detachably connected to the respectively adjacent hinged band and by means of which at least the terminating element opposite the hinged bands may be deflected out of the door leaf plane.

Accordingly, a completely new design is suggested in that, for the first time, a kind of double hinge arrangement is provided at least at the terminating element. Thus, the hinged bands are still reliably guided in the lateral guides so that the high speed operating characteristics, as are mostly desired, are still achievable. Furthermore, the additional hinge means opposite the adjacent hinged band is designed to be deflectable so that the terminating element is able to avoid being hit as a result of external impact such as collision with a fork-lift truck. Any damage affecting operativeness of the terminating element can thus be effectively avoided. The functionality of the door leaf can be recovered by merely returning the terminating element to the door leaf's plane without having to use any tools or even spare parts.

The inventive rolling shuttered door is thus able to provide a reliable collision protection with few constructive measures to be taken and without any adverse effect on its high speed running characteristics which are known in prior art and often demanded, so that it is considerably less susceptible to external impacts, with the danger of damaging individual elements of the door leaf being drastically reduced.

As a result, the additional hinge means may be designed such that, apart from the terminating element, it is possible to deflect a sub-section of the door leaf opposite the hinged bands out of the plane of the door leaf, with said door leaf being adjacent to the terminating element and extending across one or more of the hinge members. This provides the advantage that, in the case of a rather violent collision or a collision affecting not only the terminating element but also the neighboring lamellae or segment areas, it is also possible to take advantage of the inventive merit of the affected elements of the door leaf being able to avoid being hit by deflecting out of the door leaf's plane. The door leaf's collision protection is thus improved and the inventive industrial door is thus made even less susceptible to external impacts.

If the additional hinge means is designed such that the terminating element or the sub-section of the door leaf following it is able to be deflected to both sides from out of the door leaf plane, the inventive collision protection may become effective, with the functionality of the inventive rolling shuttered door being further improved.

Accordingly, the additional hinge means may be fixed by means of at least one snap connection opposite the respectively adjacent hinged band. Thus, unintentional deflection of the terminating element, or sub-sections of the door leaf following it, from out of the door leaf's plane, e.g. under wind load, may be reliably avoided. As a result, it is possible to further improve the functionality of the inventive rolling shuttered door, and, in particular, to meet the requirements of high speed operation with increased reliability.

Accordingly, the snap connection may be created by providing an elastically biased inhibiting pin engaging with a complementarily formed snapping part. Such a positively connecting or locking snap mechanism is known to the skilled person and may be provided with little constructive measures to be taken. Furthermore, said means is reliable and clearly defined as to its function.

If the inhibiting pin's preloading force is furthermore adjustable, the threshold force of the snap connection may be set precisely. This enables to ensure that, on the one hand, the deflectable elements of the door leaf are not disengaged from the connection to the adjacent hinged band already by a wind load, thus eliminating the snap connection, and, on the other hand, release of the deflecting elements of the door leaf becomes possible in response to a certain collision momentum, in order to be able to reliably prevent any damage thereto.

Alternatively, it is also possible to hold the additional hinge means using at least a magnetic means at the respectively adjacent hinged band. On the one hand, said means also allows to create a reliable protection from deflection as a result of a wind load and a non-destructive deflection of the terminating element etc. with a correspondingly great impact momentum. This embodiment provides the further advantage that the coupling of the additional hinge means to the adjacent hinged band is carried out in a contactless manner, so that no signs of wear will become evident. This allows an especially long service life to be achieved, with electromagnets providing a sufficient magnetic effect, and said magnets moreover comprising the advantage of the corresponding magnetic forces being adjustable, i.e. adjusting the retention force of the additional hinge means is also possible.

Moreover, the inventive industrial door may also be provided with a locking means, by means of which the additional hinge means for creating protection from intrusion respectively opposite the adjacent hinged band may be locked such that at least the terminating element is prevented from being deflected. In this manner, when the rolling shuttered door is not in use, e.g. during nighttime or over the weekend, the termination part of the door may be used as a reliable means of closure for an industrial building. Accordingly, said locking means may be equipped with a manually or automatically operable locking pin, such that the desired locking effect may be easily achieved with little constructive measures to be taken and by placing the rolling shuttered door into a rest position. As a rule, it is sufficient to have the terminating element locked with respect to the hinged bands, because, in this way, a possible deflection of adjacent sub-sections of the door leaf will inevitably also be avoided, since it is thus also impossible to lift the terminating element.

It is of further advantage to have the hinge members, which are associated to the terminating element, guided in the lateral guides by means of a carriage. As a result, it may be ensured that these hinge members are reliably guided, even if the central part of the door leaf is deflected out of the door leaf's plane, with a supportive cross-connection between the two lateral hinged bands no longer being given in this area. The carriages, therefore, appropriately stabilize the assembly so that it is possible to reliably prevent tilting moments in the area of these hinge members. Moreover, this embodiment is particularly advantageous if the door leaf drive is effected via circulating belts acting on the hinged bands in the area of the terminating element. When opening the door, shearing forces are generated, which naturally result in the hinge members of the hinged bands bending, with the effect of undesired tilting moments acting on the door leaf. A further cause for such tilting moments may be due to the belts of the door drive, which do not exactly engage in the plane of the guide rollers. The assembly of the carriages may counteract this phenomenon, because the positive connection of the carriage prevents the hinge member adjacent to the terminating element from tilting. With a lower hinge member arranged on the bottom side, which is exclusively guided by carriages, undesired stress load might be generated owing to the inevitably tilting phenomenon. By arranging the carriage in the lateral guides, it is thus possible to provide the high-speed running characteristics of the inventive rolling shuttered door in a still more reliable and stable manner. The assembly of a carriage has the further advantage that the guide rollers experience less great stresses in these hinge members, if a collision of a fork-lift truck or the like with the terminating member occurs and thus a force is generated acting normal to the door leaf's direction of motion. Therefore, exactly in this area having a high risk of collision, the hinged bands are held in the lateral guides, and, thus in the door leaf plane, with particular reliability, while not being inclined to following the deflecting motion of the terminating element. As a result, the reliability and service life of the inventive rolling shuttered door may be further improved.

Moreover, it is also possible for the inventive rolling shuttered door to comprise a control unit having a sensor, with a deflecting motion of the terminating element, or sub-section of the door leaf following it, opposite the door leaf plane being detectable by a sensor, and, wherein the control unit initiates a failure routine in response thereto. This offers the advantage of a collision becoming immediately detectable, and, at the same time, appropriate measures being taken on a fully automated basis, so as to keep damages of the door leaf or any risks for persons as limited as possible.

The control unit in the failure routine may cause an automated stop of the moving door leaf so that further damage of the lamellae, or door leaf segments, or stiffening profiles etc., may be reliably prevented.

It is of further advantage for the control unit in the failure routine to initiate, possibly subsequent to the automated stopping process, an opening motion of the door leaf, with the industrial door in the area of the lintel further being provided with a return means, by means which of it is possible to return a deflecting process of the terminating member or of the sub-section of the door leaf adjacent thereto. In this manner, the failure routine simultaneously initiates the recovery of the operativeness of the inventive rolling shuttered door. Since the terminating element etc. usually does not get damaged, as it was able to avoid being hit by an object, recovery of the operativeness of the inventive rolling shuttered door is possible within seconds.

As a result, the control unit may process the failure routine such that the opening motion of the door leaf is performed at a speed reduced in view of the normal operation. This is particularly advantageous with fast-moving industrial doors, since any possible danger for persons standing near the rolling shuttered door or further damage to the door leaf by e.g. the deflected central part may be avoided in an even more reliable manner.

The inventive rolling shuttered door will be explained below with reference to embodiments and the figures in the drawings attached thereto, in which:

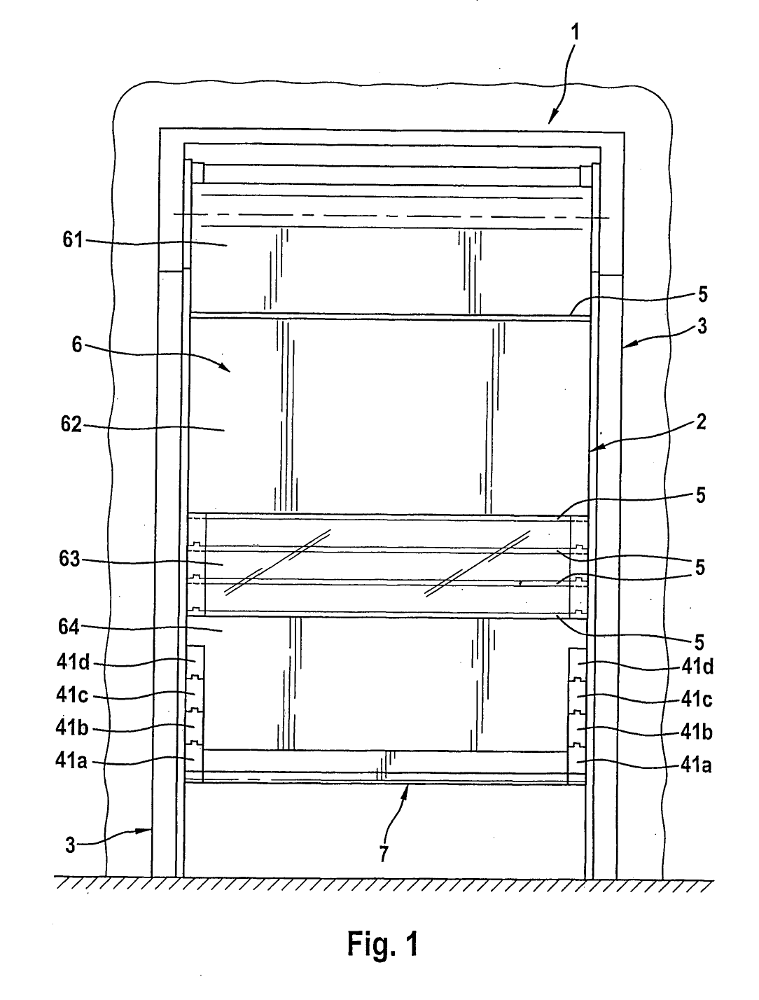

FIG. 1 is a front view of the inventive rolling shuttered door;

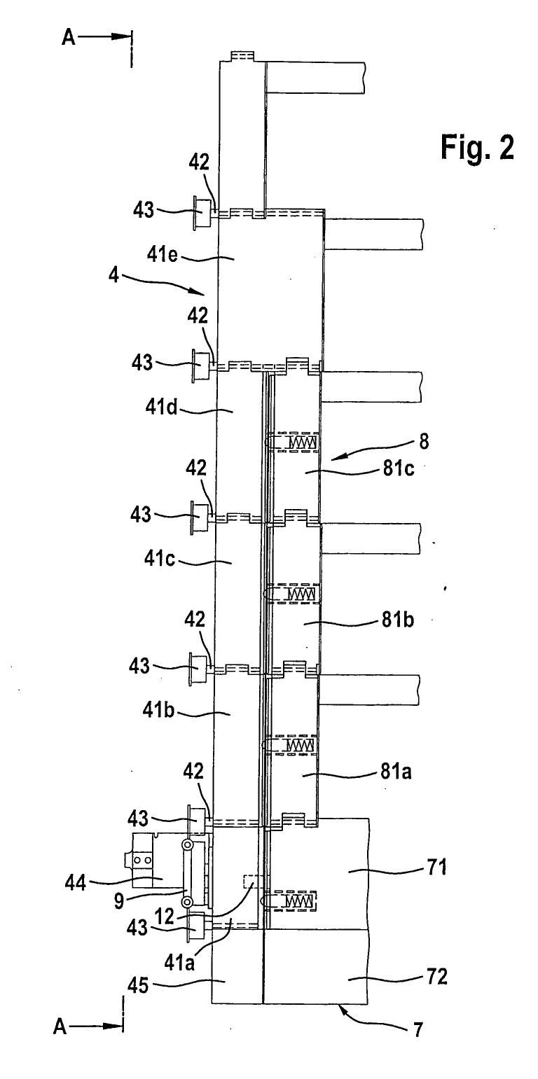

FIG. 2 is a rear view of a detail of the inventive rolling shuttered door;

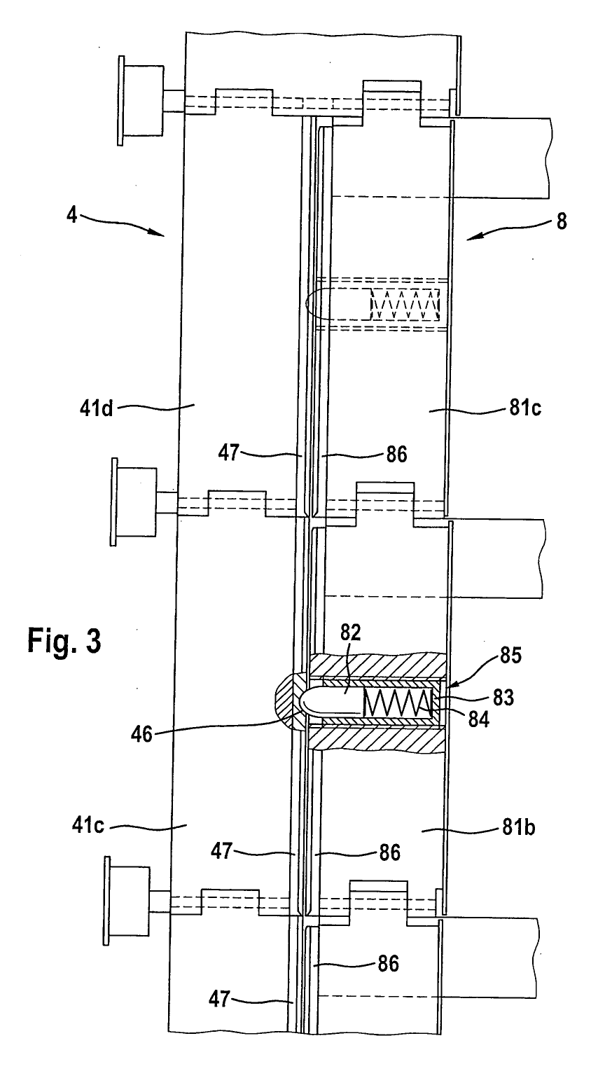

FIG. 3 is an enlarged cut-out of the illustration in FIG. 2;

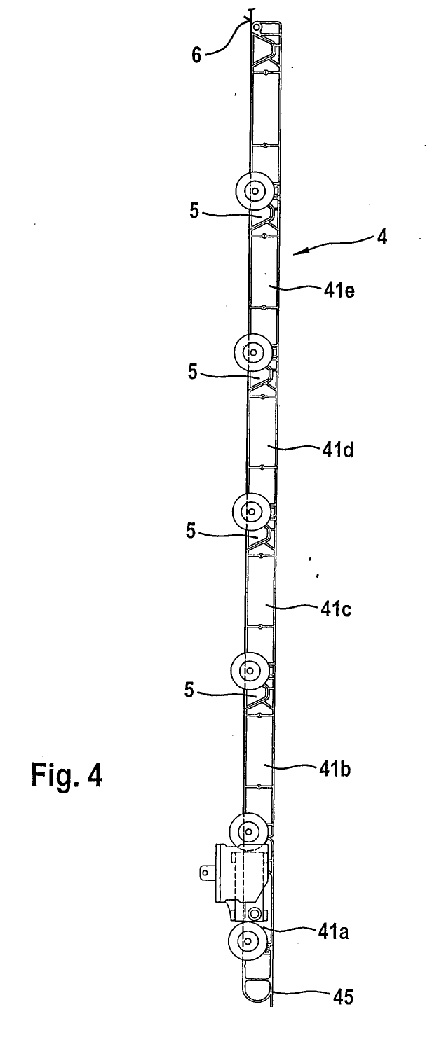

FIG. 4 a view in accordance with the cut-out A-A in FIG. 2;

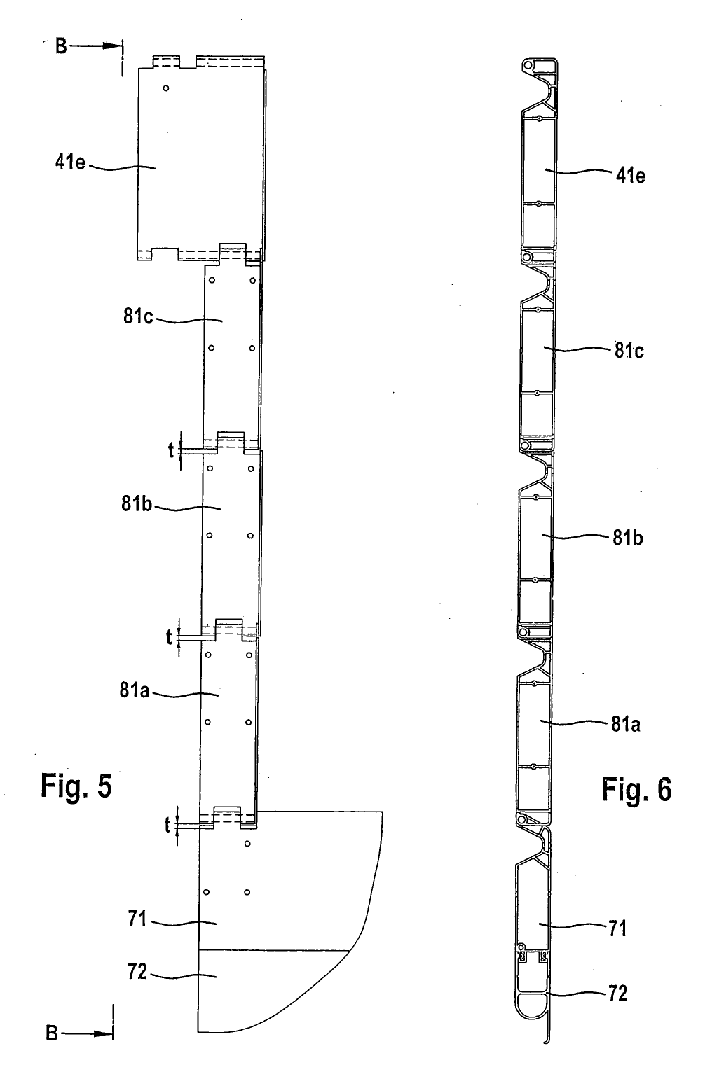

FIG. 5 is a detailed view of the hinge means;

FIG. 6 is a view in accordance with the cut B-B in FIG. 5;

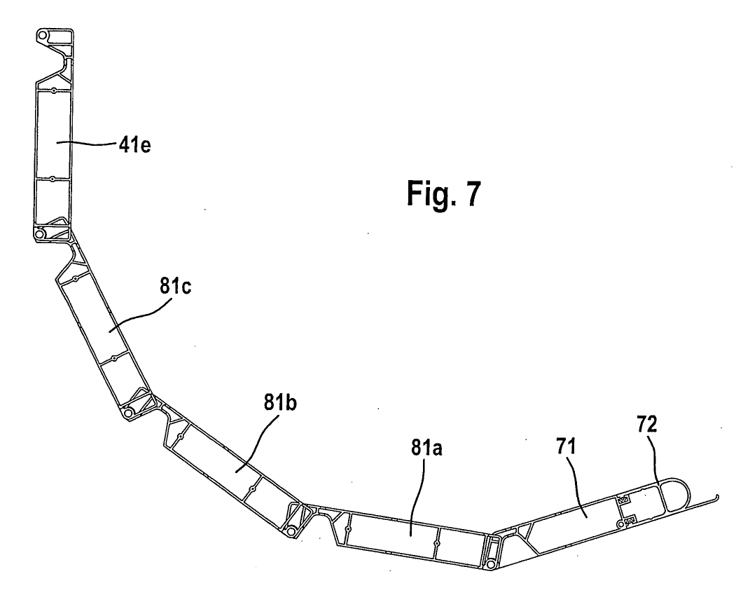

FIG. 7 is the hinge means in accordance with FIG. 5 and 6 in a bent condition;

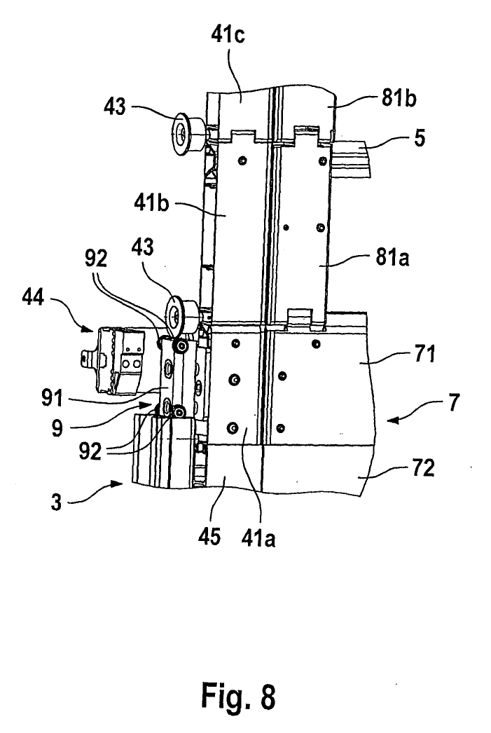

FIG. 8 a perspective detailed view of the inventive rolling shuttered door in the area of the carriage;

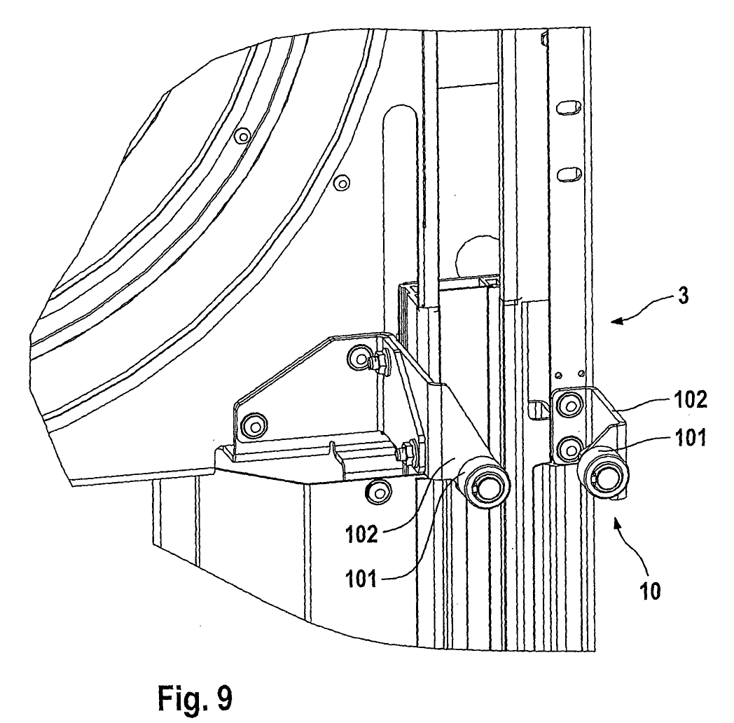

FIG. 9 is a perspective representation of the return means; and

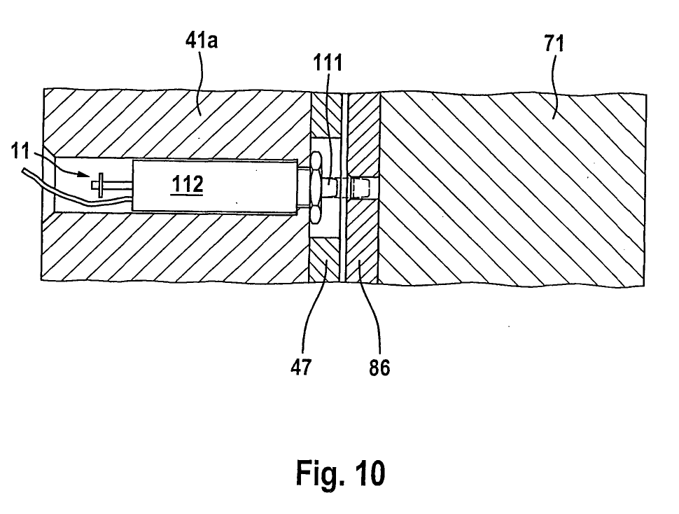

FIG. 10 is a cut through the terminating strip and the hinge member associated therewith for illustrating the locking means.

In accordance with FIG. 1, the rolling shuttered door comprises a door leaf 2 being held in lateral guides 3. The door leaf 2 comprises lateral hinged bands 4 each arranged in the area of the guides 3, which are made up of a multitude of hinge members, the hinge members 41a-41e of which may be recognized in further detail, in particular in FIGS. 2 to 4. Two respectively associated hinge members are connected to each other by a stiffening profile 5 extending in the cross direction to the lateral guides 3, so that the hinged bands 4 including the stiffening profiles 5 form a stable, but bendable scaffold.

Flexible hangings 6 made of plastic, which, in the present embodiment are divided in sub-segments 61, 62, 63, and 64, are held to the stiffening profiles 5 by means of a reinforcing strip connection. Since the sub-segment 63 of the hangings 6 is transparently formed, the stiffening profiles 5 in FIG. 1 being provided behind are marked to be visible. As is further evident from FIG. 1, the door leaf 2 moreover comprises a terminating element 7, the bottom side of which is provided with a rubber seal or the like. The present structure of the door leaf 2 including hinged bands 4, stiffening profiles 5 and hangings 6 corresponds to Applicant's “High Speed Turbo Roll-Up Door STR” as already described in the introductory part of the description, as is also described in the German patent specification DE 10236648.9, the disclosed contents of which is incorporated by reference.

As may be further appreciated from FIG. 1, the lower sub-segment 64 of the hangings 6 is recessed in the area of the four lower hinge members 41a-41d of the hinged bands 4, so as not to oppose a deflecting motion of a central part of the door leaf 2 in case of a collision.

In FIG. 2, this sub-section of the rolling shuttered door 1 is shown in closer detail, with FIG. 2 illustrating a rear view of the end portion of the door leaf 2 which is shown on the bottom right corner in FIG. 1. The end portion of the door leaf 2 provided on the other side of the door opening is structured laterally reversed. In this rear view in accordance with FIG. 2, a further hinge means 8 may be recognized beside the hinged band 4 which extends in parallel thereto. In the present embodiment, said hinge means 8 includes three members 81a-81c, the functional dimensions of which correspond to the adjacent hinge members 41b-41d, i.e. they allow to be bent with respect to each other by the same axes. Finally, a terminating strip 71 of the terminating element 7 is coupled to the next member 81a on the ground side in an articulated manner. The ground-side termination of the terminating member 7 thus forms a rubber seal 72.

As is particularly evident from FIG. 2, the hinge member 41e is provided with a width being essentially as wide as the hinge member 41d and the member 81c adjacent thereto together. The hinge member 41e thus represents the transition to the sub-section of door leaf 2, which consists of several parts.

The terminating element 7 or members 81a-81c may be pivoted around axes being coaxially provided to the axis of rotation of the hinge members 41a-41d. Rollers 43 are supported by the rotational axes 42. The rollers 43 themselves are positively connected in a known manner to the lateral guides 3, thus guiding the door leaf 2.

As may be further taken from FIG. 2, a mounting 44 for a tooth belt drive, which is not shown, is further fixed to the lower hinge member 41a. Furthermore, the bottom side of the lower hinge member 41a is also provided with a rubber seal 45.

As may be further taken from closer detail of FIG. 3, the hinge means 8 in this embodiments is connected to the adjacent hinged member 4 by means of a positively connecting or locking snap mechanism. Said positively connecting or locking snap mechanisms each comprise an inhibiting pin 82 accommodated in a receptacle 83 in the respective hinge member 81a-81c and being biased by means of a spring 4 in the direction of the adjacent member 41a-41d of the hinged band 4. The receptacle 83 accordingly comprises an external thread, by means of which it is adjustably held in a retaining hole 85 having an internal thread. In other words, the preloading force of the spring 84 may be adjusted by moving the receptacle 3 with respect to the retaining hole 85.

As a result, the inhibiting pin 82 positively engages with a complementarily formed snapping member 46 in the member 41a-d. In this manner, the snap connection is disengaged, this being possible with a certain threshold force, with said threshold force being adjustable by adjusting the receptacle 83 in the retaining hole 85. Since the inhibiting pin 82 is furthermore held in a positive connection in the receptacle 83, loss of the inhibiting pin 82, even with member 81a being swiveled out, is not possible. The remaining snap connections are identically or analogously formed, also at the terminating element 7 with respect to the hinge member 41a.

Apart from the permanent connection at the upper member 81a with respect to the hinge member 41e, hinge means 8 is only connected to the adjacent hinge members 41b-41d by means of this positively connecting or locking snap mechanism. In case of a collision, the terminating element 7 together with the sub-section of the door hangings as defined by the three members 81a-81c may be swiveled out of the door leaf plane and thus avoid being hit by the stress load.

As may be further taken from FIG. 3, sliding plates 47 and 86 are each imposed on the front sides of the hinge members 41a-41d facing each other and on members 81a-81c, or on the terminating strip 71, said sliding plates moreover comprising chamfered edges. These sliding plates 47 and 86 help to return a swiveled out central part of the door leaf 2 back into the door leaf.

In FIG. 4, the hinged band 4 is still shown in cross-section in accordance with A-A in FIG. 2. It may be appreciated therefrom that, when viewed in the thickness direction of the door leaf, the hinged members 41a-41e are pivoted near a main surface of the door leaf, so that they may be swiveled out in one direction only, that is towards the hangings 6.

In FIGS. 5 to 7, further hinge means 8 is shown in more detail. As may be especially seen from FIG. 5, the individual members 81a-81c are formed such that in the swiveling range their surfaces facing each other are spaced from each other by a predetermined amount “t”. While, even with hinge means 8, the axis of rotation of the individual members are provided adjacent to the hangings 6 of the door leaf, it is thus possible to swivel the hinge means 8 also into the opposite direction, as is shown in FIG. 7. An amount “t” of e.g. 6 mm will result in a possible swivel motion by approx. 27 degrees per hinge member in the practical example. The amount “t” may be freely selected depending on the case of application. The hinge member 8 may thus be swiveled in both directions out of the door leaf plane.

In the described embodiment the door leaf is conventionally driven by drive belts in the form of tooth belts, which are not shown here, with these drive belts engaging with the mounting 44 and pulling door leaf 2 either upwards for opening the industrial door, or downwards for closing the door leaf 2. To this end, the drive belts are formed to circulate.

As may be seen from the perspective illustration in FIG. 8 in detail, a carriage 9 is arranged at the lower hinge member 41a, i.e. in the area of the terminating element 7, said carriage comprising a carrier 91 as well as rollers 92 and also cooperating with the lateral guide 3. In FIG. 8, a sub-section of the guide 3 is shown in order to clarify the facts. The hinge member 41a is provided with a support by means of rollers 92 so as to prevent any motion in the direction of the terminating strip 71. The carriage 9 counteracts to prevent the hinge member 41a from being tilted and at the same time enables the hinge member 41a to be smoothly guided in the lateral guide 3. The danger of the hinge member 41a of getting tilted is given only, e.g., when there is no more cross connection to the other side of the door with the central part of the door deflected, so that the peripheral parts of the door leaf 2 essentially formed by the two hinged bands 4 are no longer able to support each other. Further tilting moments occurring during the opening and closing motion of the door leaf 2 may thus be reliably absorbed by carriage 9 arranged on the two sides of the rolling shuttered gate 1.

Moreover, on the one hand, the danger of the hinge member 41a getting tilted is given during the opening motion due to driving forces acting via the mounting 44, and, on the other hand, this danger is given even more so by collisions, since corresponding normal forces act onto the main surface of the door leaf 2 at least as long as the central part of the door leaf 2 has not yet swiveled out of the door leaf plane despite forces being applied. Such forces may be reliably received by the carriage 9 such that damage of the rollers 43 adjacent thereto and/or of the drive unit cooperating with the mounting may be avoided permanently.

FIG. 9 shows a perspective illustration of a return means 10 of the rolling shuttered door 1. As may be appreciated therefrom, the return means 10 comprises two cooperating rollers 101 being spaced apart from each other, each of which is supported at a lateral guide 3 by means of a mounting 102 in the area of the door lintel. The distance between the two rollers 101 essentially corresponds to the thickness of the door leaf 2. Moreover, both rollers 101 are spaced from the lateral guide 3 such that they act on the members of the hinge means 8 so as to push them back into the door leaf's plane if necessary. Thus, when performing an opening motion of rolling shuttered door 1, a central part being swiveled out of the door leaf 2 may be automatically returned.

In accordance with the illustration in FIG. 10, the industrial door 1 moreover comprises a locking means 11, by means of which the terminating strip 71 may be locked with respect to the adjacent hinge member 41a. In this respect, the locking means 11 contains a locking pin 111, which allows to be moved in a controlled manner by means of an electric drive, an electric motor 112, and which positively engages with a corresponding recess at the adjacent sliding plate 86 at terminating strip 71.

Further, the industrial door 1 comprises a control unit detecting, by means of a sensor 12 (cf. FIG. 2), a deflecting motion of the door leaf 2 out of the door leaf plane. To this end, the sensor 12 is arranged in the lowermost hinge member 41a and refers to the terminating strip 71. If the same is no longer detectable by the sensor 12, a failure routine is automatically triggered, during which the door leaf 2 is stopped and made to carry out an opening motion.

Apart from the illustrated embodiment, the invention allows for further approaches as to its embodiments.

Depending on the case of application, it may vary the number of members of the hinge means 8. The size of the sub-section of the door leaf 2 being able to be swiveled out of the door leaf's plane may thus be adjusted. In a particular embodiment, only the terminating element 7 may be pivotably held at the hinge means 8 so that only the terminating element 7 is able to perform a deflecting motion.

The mounting the of the hinge means 8 at the hinged band 4 may also be embodied in another manner than using the described positively connecting or locking snap mechanisms, e.g. by means of electromagnets. In this, the number of the positively connecting or locking snap mechanisms and the electromagnets being alternatively provided may vary and be selected corresponding to the respective requirements. The inhibiting pin may moreover be supported in a hinge member of the hinged band 4, while the assigned snapping part is disposed in the hinge means 8. Moreover, any other kind of connection by means of snap elements, adhesion or buttoning is possible.

Further, it is also possible to use the inventive embodiment with a door leaf which is formed in the manner of an armor of lamellae. Examples for such armors of lamellae are known from the specifications of DE 40 15 214 A, DE 40 15 216 A, and DE 199 15 376 A1. A further possibility of application for the invention refers to rolling shuttered doors having flexible hangings coiled in the area of the lintel of the door. Accordingly, such hangings may simply be slitted in the direction of motion of the door leaf and connected to each other by means of buttons.

Furthermore, it is also possible not to effect the driving operation of the door leaf via drive belts and thus not introduce any forces at the terminating element 7. Instead, the drive motion may also be applied to the upper end of the door leaf and, therefore, pull the door leaf into its storage position above the door lintel during opening, while applying a pushing motion to the same during the closing operation. Examples for top-drive door leaves are known from practice. In this case, it is possible to eliminate the need for the carriage 9, since the tilting moments for this way of driving, which are created at the lower hinge member 41a, are considerably reduced.

In the place of a carriage 9, it is possible to dispose a sliding block at the lower hinge member 41a which may be formed of a slidable material, in particular, PTFE or the like, and which also positively connects with the guide 3 in the same way as the rollers 43 do. To this end, the sliding block would be formed in the shape of a cuboid and would thus create a sliding surface cooperating with guide 3 in a plane parallel to the extension of guide 3, so that tilting of the hinge member 41a is avoided by way of a positive connection in a clearance fit.

Instead of rollers 101, the return means 10 may also include sliding elements along which the deflected central part of the door leaf 2 slides along, thus being returned to the door leaf's plane.

In order to prevent the peripheral parts of the door leaf from being damaged, they are relatively narrow as compared to the central part. Moreover, it is also possible to form several deflectable central parts at the door leaf, which may be especially reasonable in the case of very wide doors.

The inhibiting pin 111 may also be driven or actuated by any other electrical means than the electromagnets 112 or on a purely mechanical basis. Furthermore, the locking means 11 and/or the sensor 12 may also be provided in another hinge member or in a member of the hinge means 8.

The hinged bands 4 and/or the hinge means 8 may also be formed as a relatively flat hinge means being disposed on a main surface of the door leaf 2.

1-14. (canceled)

15. A rolling shuttered door (1), in particular, a fast-moving industrial door, having a door leaf (2) covering the door opening and being guided in lateral guides (3),
with the door leaf (2), in a sub-section facing the footprint of the rolling shuttered door (1), being divided into several parts extending in the direction of movement of the rolling shuttered door (1) such that a peripheral part guided in lateral guides (3) is provided on both sides and a central part extending between the two peripheral parts, which is detachably fixed to the peripheral parts,
characterized in that,
the door leaf (2) comprises a hinged band (4) on both sides having a plurality of bendable hinge members (41a-41e) connected to each other, which are guided in the lateral guides (3) by means of rollers (43), with the door leaf (2) further comprising a ground-side terminating element (7), and with an additional hinge means (8) being arranged at the door leaf (2), respectively adjacent to the hinged band (4) on the side opposite to the lateral guides (3) at least in the area of the terminating element (7), said hinge means (8) being detachably connected to the respectively adjacent hinged band (4) and by means of which it is possible to deflect at least the terminating element (7) opposite the hinged band (4) out of the door leaf plane, and
that it comprises a control unit having a sensor (12), with a deflection of the terminating element (7) or of the adjacent sub-section of the door leaf (2) opposite the door leaf plane becoming detectable by means of sensor (12), and with the control unit introducing a failure routine in response thereto.

16. A rolling shuttered door according to claim 15, characterized in that the additional hinge means (8) is formed such that, apart from the terminating element (7), a sub-section of the door leaf (2) following the terminating element and extending across one or several of the hinge members (41b-41e) opposite the hinged bands (4)is able to be deflected to both sides of the door leaf plane.

17. A rolling shuttered door according to claim 15, characterized in that the additional hinge means (8) is formed such that the terminating element (7) or the sub-section of the door leaf (2) following the same is able to be deflected to both sides out of the door leaf plane.

18. A rolling shuttered door according to claim 15, characterized in that the additional hinge means (8) is fixed by means of at least one snap connection opposite the respectively adjacent hinged band (4).

19. A rolling shuttered door according to claim 18, characterized in that the snap connection is created by an elastically biased inhibiting pin (82), which engages with a complementarily formed snapping element (46).

20. A rolling shuttered door according to claim 19, characterized in that the preloading force of the inhibiting pin (82) is adjustable.

21. A rolling shuttered door according to claim, characterized in that additional hinge means (8) is fixed to the respectively adjacent hinged band (4) by means of at least a magnetic means, in particular, an electromagnet.

22. A rolling shuttered door according to claim 15, characterized in that it comprises a locking means (11), e.g. having a manually or automatically operable locking pin (111), by means of which the additional hinge means (8) for creating protection from intrusion respectively opposite the adjacent hinged band (4) being lockable such that a deflection of at least the terminating element (7) is avoided.

23. A rolling shuttered door according to claim 15, characterized in that the hinge members (41a) associated with the terminating element (7) are each guided in the lateral guides (3) by means of a carriage (9).

24. A rolling shuttered door according to claim 15, characterized in that the control unit in the failure routine causes an automatic stop regarding the movement of the door leaf (2).

25. A rolling shuttered door according to claim 15, characterized in that the control unit in the failure routine, possibly subsequent to an automatic stop, introduces an opening motion of the door leaf (2), with the rolling shuttered door (1) in the area of the door lintel being further provided with a return means (10), by means of which it is possible to return a deflection of the terminating element or of the sub-section of the door leaf adjacent thereto.

26. A rolling shuttered door according to claim 25, characterized in that the opening motion of the door leaf (2) is performed at a reduced speed as compared to normal operation.
